(19) United States
(12) Patent Application Publication
(10) Pub. No.: US 2011/0030046 A1
(43) Pub. Date: Feb. 3, 2011

(54) GUARDIAN MANAGEMENT SYSTEM

(76) Inventors: David A. Shemenski, North Aurora, IL (US); Edmond B. Lewis, Chicago, IL (US)

Correspondence Address: DYKEMA GOSSETT PLLC, 39577 WOODWARD AVENUE, SUITE 300, BLOOMFIELD HILLS, MI, 48304-5086, US

(21) Appl. No.: 12/815,039

(22) Filed: Jun. 14, 2010

Related U.S. Application Data
(60) Provisional application No. 61/186,801, filed on Jun. 12, 2009.

(51) Int. Cl. H04L 9/32; G06F 21/00; G06F 15/16

(52) U.S. Cl. 726/9

(57) ABSTRACT

A computer-implemented method for allowing a guardian for a dependent to manage electronic services provided by a third party service provider to the dependent comprises the steps of: establishing an account for the dependent with the service provider by providing at least one item of dependent information; communicating the dependent information to a guardian management system; generating a token that is associated with the dependent information; storing the at dependent information and the token at the guardian management system; communicating the token to the service provider; storing the dependent information and the token at the service provider; communicating the token to the guardian; receiving at least one constraint on access to the service provider from the guardian; associating the at least one constraint with the token; and using the token to retrieve the at least one constraint when the dependent accesses the electronic services provided by the service provider.

### CROSS REFERENCE TO RELATED APPLICATIONS

This application claims the benefit of U.S. provisional application no. 61/186,801, filed 12 Jun. 2009, which is hereby incorporated by reference as though fully set forth herein.

### TECHNICAL FIELD

The present invention relates to a system that enables a guardian to enable and disable features on a dependent's access to and use of electronic social network services (a “Guardian Management System” or “GMS”).

### BACKGROUND

In general, electronic social network services include those that enable the transfer of text, graphic, video and voice data from one entity (one or more people) to another over electromagnetic channels, such as the Internet and mobile communication systems. Examples of such social network services include mobile voice, email, instant messaging, text messaging (such as SMS), picture messaging (such as MMS), Voice-over-IP (VoIP), online gaming, virtual worlds, online social networks and website access in general.

Dependents (those who rely on another entity for support) such as children, have generally developed social networks in the physical world through interactions with others through school, play and social connections. In these contexts, it is possible for guardians (entities who have responsibility and/or care for one or more dependents) such as parents, to have some level of control over a dependent's interactions. The GMS enables guardians to extend the physical world social networks of dependents into the electronic world and place constraints on the nature of the interactions dependents may have with electronic services and the users of these services. By placing constraints on, for example, with whom, what services and how long the dependent may interact electronically, a guardian is in essence able to create and manage a customized electronic social network for their dependent.

### SUMMARY

A computer-implemented method for allowing a guardian for a dependent to manage electronic services provided by a third party service provider to the dependent comprises the steps of: establishing an account for the dependent with the third party service provider by providing at least one item of dependent information; communicating the at least one item of dependent information from the third party service provider to a guardian management system; generating a token that is associated with the at least one item of dependent information; storing the at least one item of dependent information and the token at the guardian management system; communicating the token to the third party service provider; storing the at least one item of dependent information and the token at the third party service provider; communicating the token to the guardian; receiving at least one constraint on access to the third party service provider from the guardian; associating the at least one constraint with the token; and using the token to retrieve the at least one constraint when the dependent accesses the electronic services provided by the third party service provider.

A guardian management system for allowing a guardian for a dependent to manage electronic services provided by a third party service provider to the dependent comprises: a third party interface block configured to enable communication between the guardian management system and the third party service provider; a dependent identifier registration module configured to generate a token associated with the dependent and the third party service provider; a guardian interface block configured to enable communication between the guardian management system and the guardian; a dependent registration module configured to enable the guardian to define at least one constraint on access to the third party service provider, the at least one constraint associated with the token; a data repository in communication with the dependent identifier registration module and the dependent registration module and configured to store the token and the at least one constraint associated with the token; and an inquiry module configured to retrieve the at least one constraint using the token and communicate the at least one constraint to the third party service provider.

### BRIEF DESCRIPTION OF THE DRAWINGS

Embodiments of the invention will now be described, by way of example, with reference to the accompanying drawings, wherein:

FIG. 1 is a schematic drawing of a network including a GMS in accordance with an embodiment of the invention.

FIG. 2 is a diagram of the data structures stored and utilized by third party service providers in connection with the GMS of FIG. 1.

FIGS. 3A-3H are diagrams of the data structures stored and utilized by the GMS of FIG. 1.

FIGS. 4-8 are representative screenshots of a GMS in accordance with an embodiment of the invention.

FIG. 9 is a schematic drawing of a network including a GMS and a fourth party monitoring system in accordance with an embodiment of the invention.

### DETAILED DESCRIPTION

Reference will now be made in detail to embodiments of the present invention, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as embodied by the appended claims.

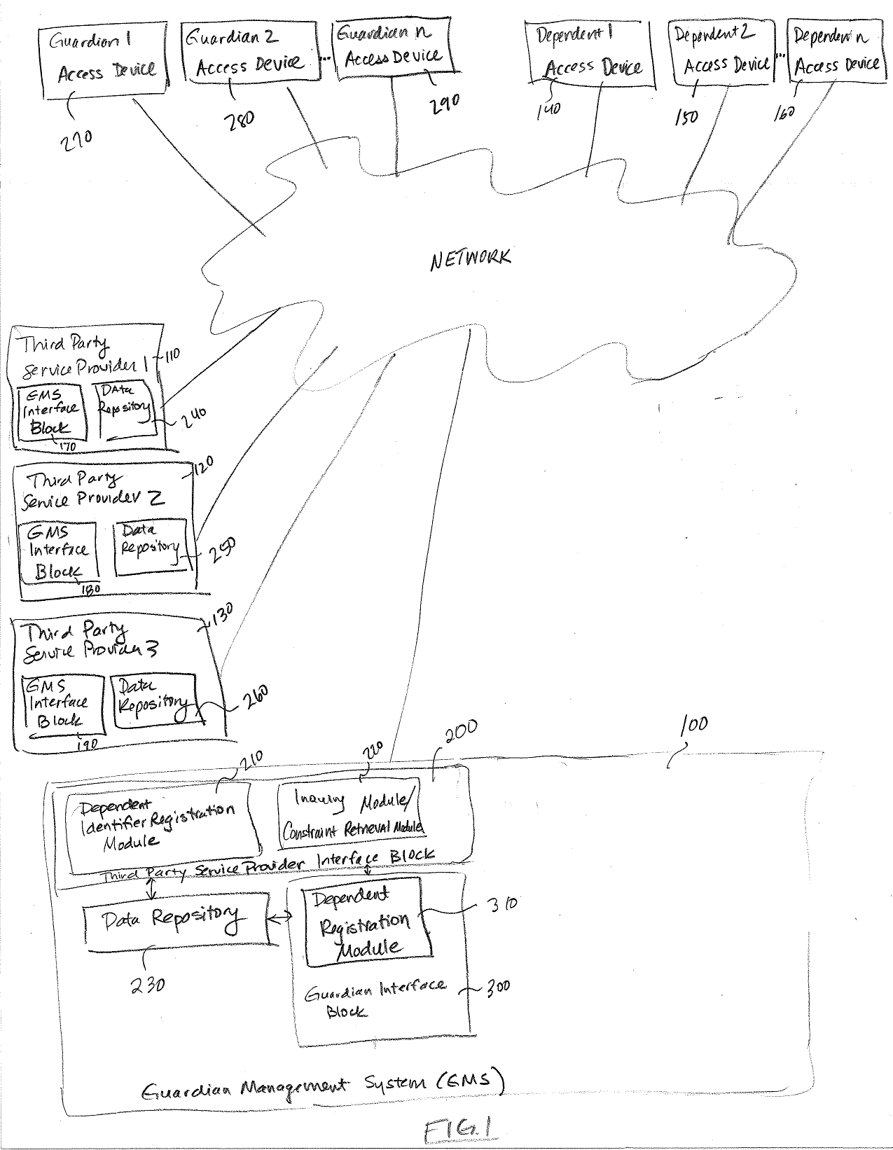

FIG. 1 generally illustrates a schematic drawing of a network including a GMS 100. The GMS 100 is a computer-implemented system. The GMS 100 is configured to enable a plurality of guardians (e.g., Guardian 1, Guardian 2, and/or Guardian n) to define and/or constrain access to electronic services provided by a third party service provider 110, 120, 130 by their respective dependents (e.g., Dependent 1, Dependent 2, and/or Dependent n). Any number of guardians and any number of dependents may be included in accordance with an embodiment of the invention. Each guardian may be responsible for one or more dependents in accordance with an embodiment of the invention.

When a dependent, such as Dependent 1, Dependent 2, and/or Dependent n, attempts to access a third party service provider 110, 120, 130 for the first time (via dependent 1 access device 140, dependent 2 access device 150, and/or dependent n access device 160, for example), the dependent is generally required to register with the third party service provider 110, 120, 130. Dependent access devices 140, 150, 160 may include commercially available desktop computers, notebook computers, server computers, personal digital assistants (PDA's) as well as mobile computing and communications devices. When the dependent registers with the third party service provider 110, 120, 130, the third party service provider 110, 120, 130 provides, or allows the dependent to choose, a user name and password. This user name and password are needed by the dependent to access the services provided by the third party service provider 110, 120, 130. The third party service provider 110, 120, 130 may comprise a social networking site, a gaming site, a content website, and the like and may include mobile voice, email, instant messaging, text messaging (such as SMS), picture messaging (such as MMS), Voice-over-IP (VoIP), online gaming, virtual worlds, online social networks and website access in general in accordance with various embodiments of the invention.

The third party service provider 110, 120, 130 may also request additional information used to identify and/or notify the guardian for the dependent. For example and without limitation, various third party service providers 110, 120, 130 may request a guardian e-mail address, a guardian cell phone number, a guardian credit card number, a guardian driver's license number, and/or any number of other various items of information that may be used to identify and/or notify the guardian for the dependent seeking to register with the third party service provider 110, 120, 130. Accordingly, the information already generally requested by the third party service provider in the course of its services may be utilized by the GMS 100 to allow the guardian to place constraints on the services (e.g., enable and disable features on access to the services) by his/her dependent(s) in accordance with the invention.

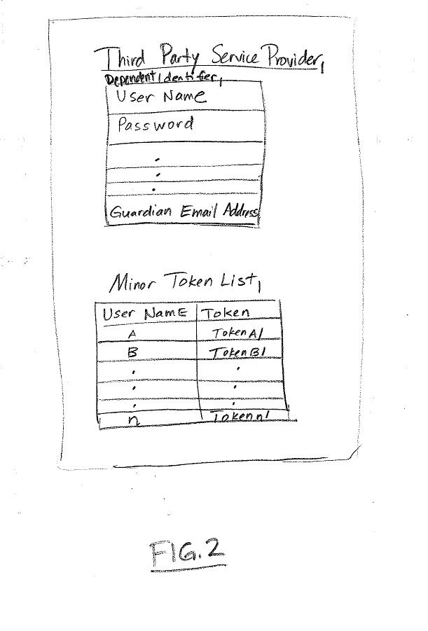

The third party service provider 110, 120, 130 may store information pertaining to the dependent (i.e., referred to as a dependent identifier) that may allow the third party service provider 110, 120, 130 to identify the dependent. The dependent identifier (e.g., dependent identifier 1, as generally illustrated in FIG. 2) may include, for example, the dependent's user name, the dependent's user password, the dependent's guardian e-mail address. The dependent identifier may include other items of information in accordance with other embodiments of the invention. For example, the dependent identifier may include the guardian cell phone number, the guardian credit card number, the guardian's driver's license number, and/or any number of other various items of information. In particular, the dependent identifier may comprise any item of information obtained by the third party service provider 110, 120, 130 relating to the guardian of the dependent seeking to register with the third party service provider 110, 120, 130.

The dependent identifier is communicated from the third party service provider 110, 120, 130 to the GMS 100. The dependent identifier may be communicated in either an automated or manual manner. In accordance with an embodiment of the invention, the communication from the third party service provider 110, 120, 130 to the GMS 100 may comprise a message formatted at the third party service provider 110, 120, 130. The third party service provider 110, 120, 130 includes a GMS interface block (e.g., GMS interface block 170, 180, 190) that is configured to communicate with the GMS 100 and that allows for interoperability of the third party service provider 110, 120, 130 with the GMS 100.

Still referring to FIG. 1, the GMS 100 generally includes a third party interface block 200. The third party interface block 200 may include a dependent identifier registration module 210 and an inquiry module/constraint retrieval module 220 as described further herein. The GMS generally also includes a guardian interface block 300. The guardian interface block 300 may include a dependent registration module 310 as described further herein. The blocks 200, 300 of the GMS 100 may be implemented using conventional hardware and operating systems known in the art. The hardware includes conventional processing capabilities as well as memory storage (e.g., random access memory (RAM), read-only memory (ROM), etc.). Conventional operating systems may be employed, such as variants of the Windows operating system (e.g., Windows 7, Windows Vista, etc.), Macintosh OS X, Linux, as well as other conventional operating systems found on mobile devices, for example.

The third party interface block 200 of the GMS 100 may enable communication between the GMS 100 and the one or more third party service providers 110, 120, 130. Any number of third party service providers 110, 120, 130 may offer electronic services to dependents. Accordingly, although three representative third party service providers 110, 120, 130 are mentioned in detail, there may be a fewer or more service providers in accordance with other embodiments of the invention. The third party interface block 200 of the GMS 100 includes a dependent identifier registration module 210 and an inquiry module/constraint retriever module 220. The GMS 100 further includes a data repository 240.

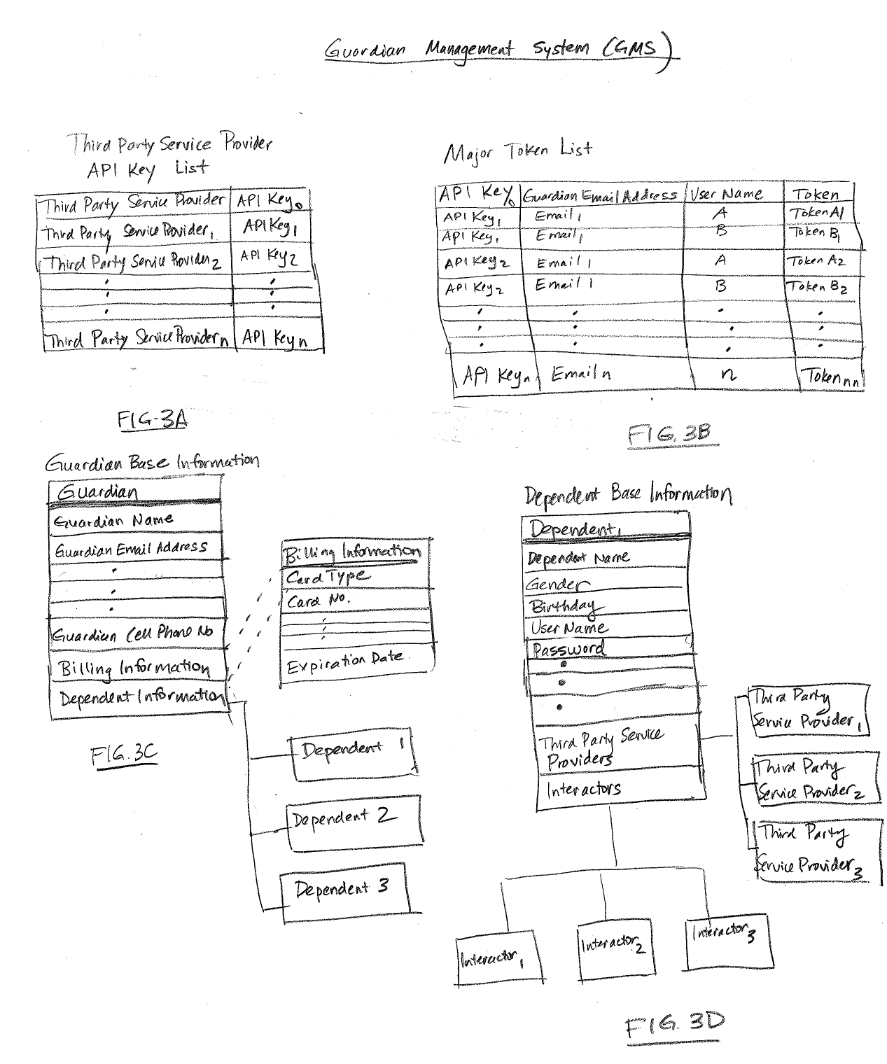

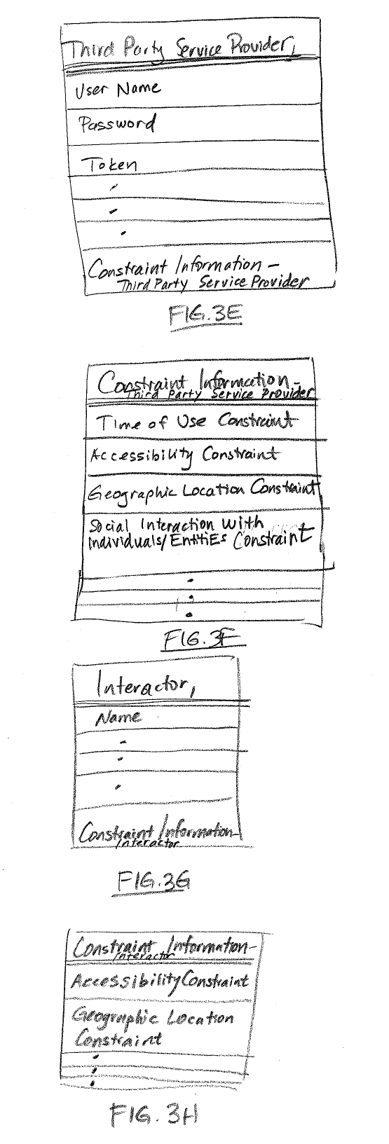

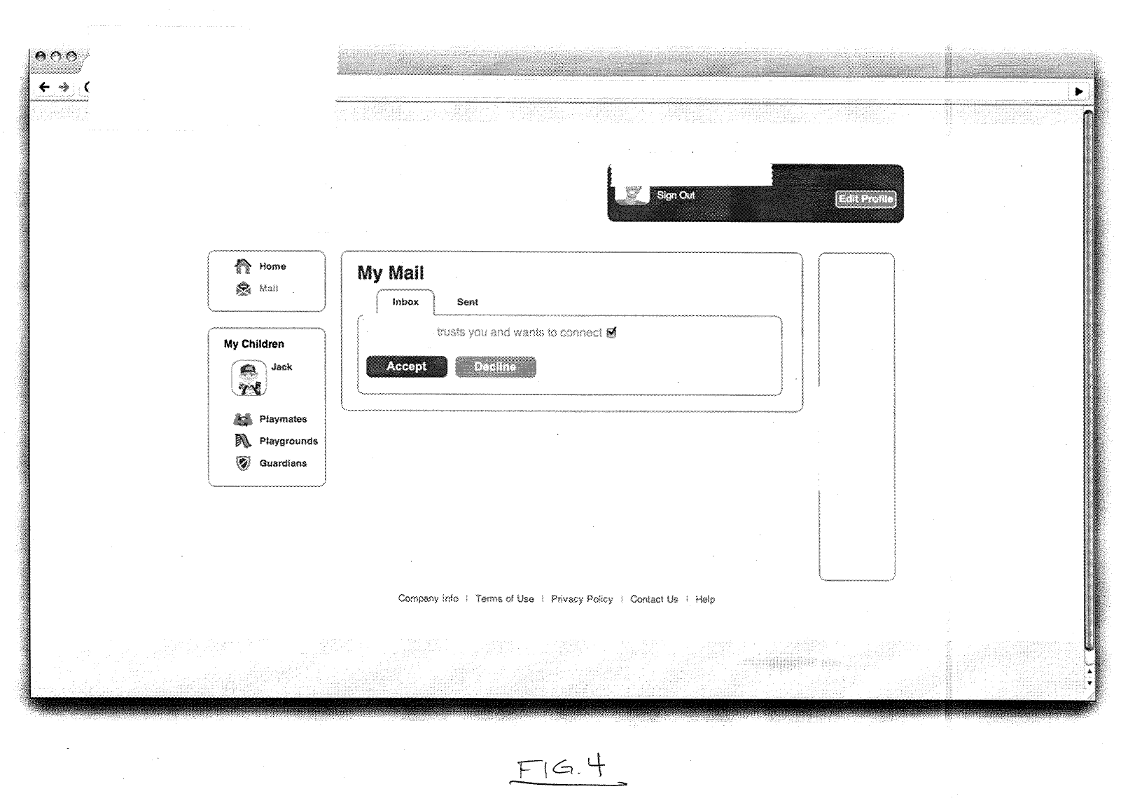

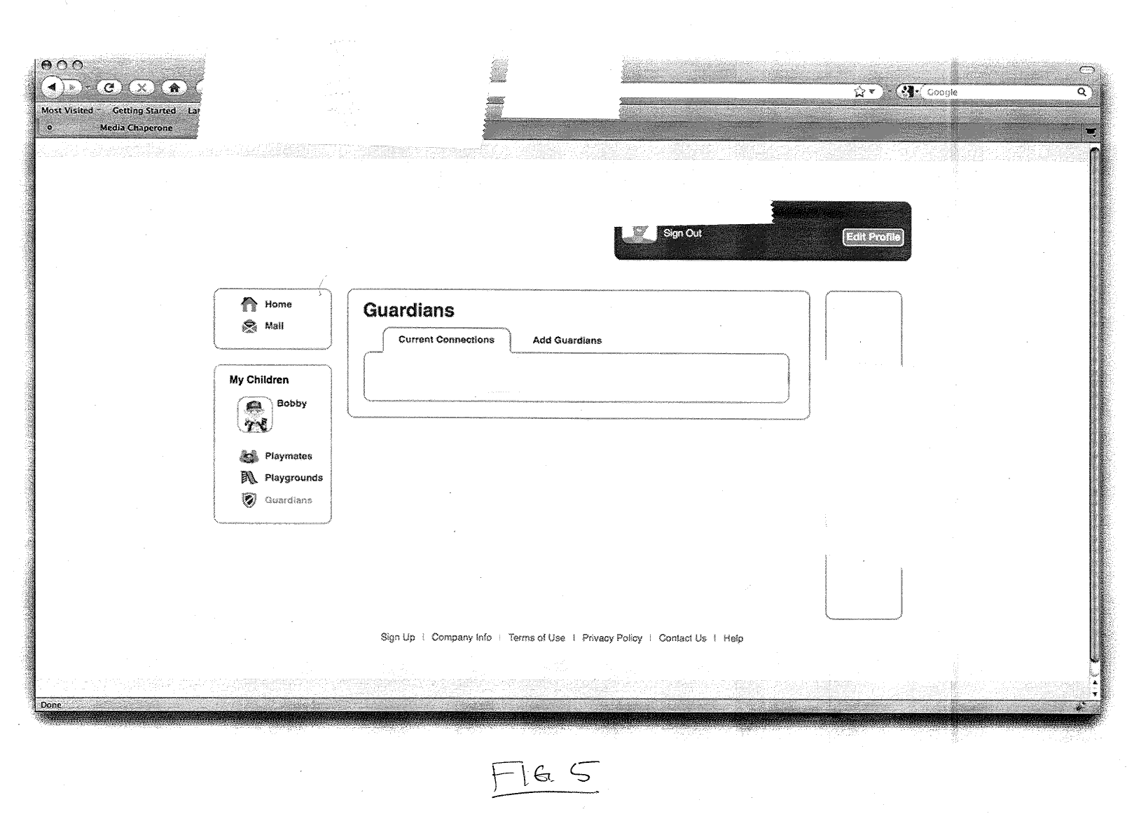

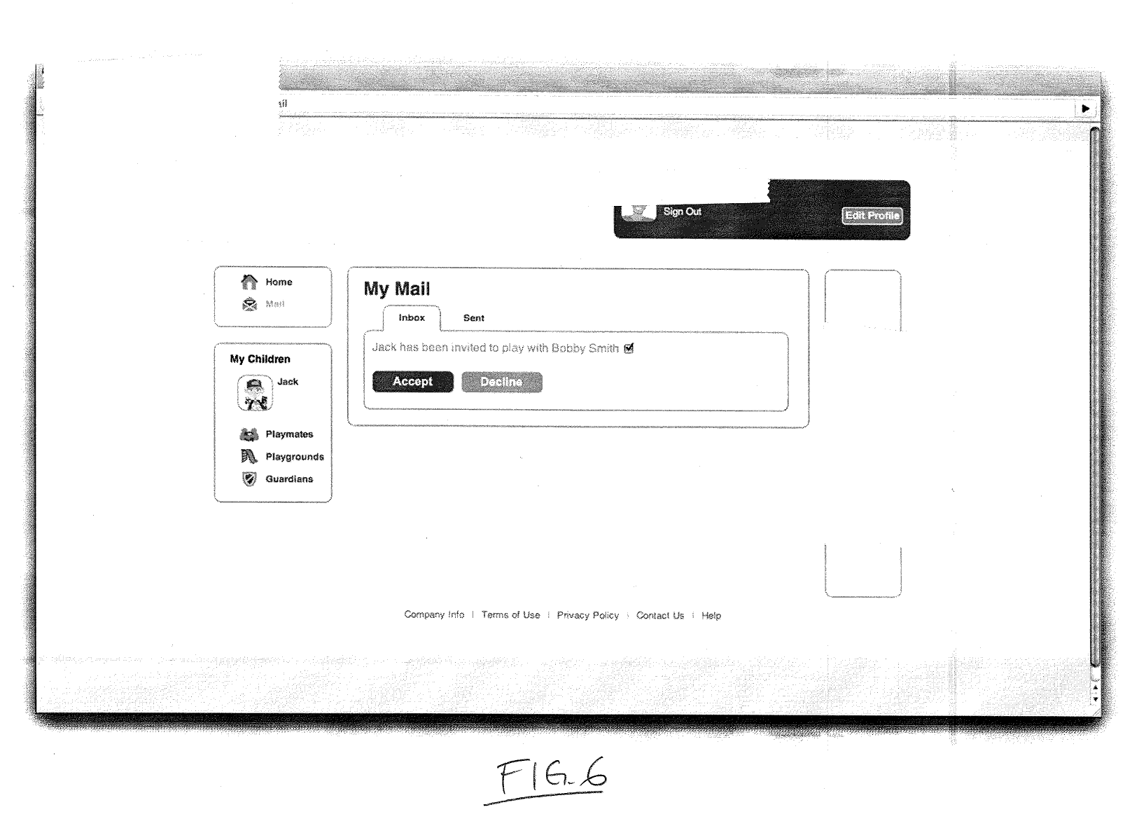

The dependent identifier registration module 210 generates a unique token that is associated with the dependent identifier (i.e., the dependent's user name and the dependent's guardian e-mail address and/or or other various items of information that may be used to identify and/or notify the guardian for the dependent that is seeking to register with the third party service provider). The token comprises a unique alphanumeric string in accordance with an embodiment of the invention. The dependent identifier registration module 210 also associates the unique token with the third party service provider 110, 120, 130, since the same user name (and guardian e-mail address) could potentially be used across multiple third party service providers 110, 120, 130. The unique token may be associated with the third party service provider 110, 120, 130 through the use of a unique API (application programming interface) key that may be assigned to the third party service provider 110, 120, 130 by the GMS 100. Referring now to FIG. 3A, the data repository 230 of the GMS 100 stores a Third Party Service Provider API Key list correlating each third party service provider 110, 120, 130 with an API key. The GMS is configured to generate a unique token for a particular user name for a particular third party service provider 110, 120, 130. The dependent identifier registration module 210 communicates the unique token identifying the dependent in the particular third party service provider 110, 120, 130 in the data repository 230 of the GMS 100 for storage. Referring now to FIG. 3B, the Major Token List in the data repository 230 of the GMS 100 correlates the token with the user name, the guardian e-mail address, and/or the API key in accordance with an embodiment of the invention. The dependent identifier registration module 210 also communicates the unique token identifying the dependent in the particular third party service provider 110, 120, 130 to the third party service provider 110, 120, 130. The third party service provider 110, 120, 130 may then store the unique token associated with each user name in its respective data repository 240, 250, 260. Referring back to FIG. 2, the Minor Token List (e.g., Minor Token List 1) in the respective data repository 240 of the third party service provider 110 may correlate the token with the user name for a particular third party service provider 110. In this way, the token comprises a cross-platform identify for a dependent, which does not require the username or other information that may be more sensitive than the unique token. The GMS interface block 170, 180, 190 of the third party service provider 110, 120, 130 may include a software module that may be configured to create the Minor Token List and may be configured to have a look-up function.

The third party service provider 110, 120, 130 and/or the GMS 100 may be configured to communicate with the guardian of the dependent seeking to register with the third party service provider 110, 120, 130. For example, the guardian of the dependent seeking to register with the third party service provider may receive a notification (e.g., e-mail notification) directly from the third party service provider 110, 120, 130 or from the GMS 100 on behalf of the third party service provider 110, 120, 130. The notification may include a URL associated with the unique token that has been assigned to the dependent seeking to register with the third party service provider 110, 120, 130. The GMS 100 may include a guardian interface block 300 that enables communication between the GMS 100 and the one or more guardians utilizing guardian access devices 270, 280, 290. The guardian interface block 300 may provide a web portal accessed through the Internet (e.g., a web portal interface), configured to allow the guardian to interact with the GMS 100. The web portal interface may employ a user interface configured to solicit the needed information in order to register a dependent with the GMS 100 and/or update the information pertaining to a dependent in the GMS 100. The web portal interface is configured to be accessed by a guardian over the world wide web (WWW) portion of the Internet, using well-established communications protocols, such as hypertext transfer protocol (http), secure http (https), and the like. In this regard, it is contemplated that the web portal portion of the guardian interface block 300 of GMS 100 will include web server functionality configured to interact with conventional client-side web browser application programs executing on guardian's guardian access devices 270, 280, 290. The guardian may then be prompted to register the third party service provider 110, 120, 130 with the GMS 100. The guardian may use guardian 1 access device 270, guardian 2 access device 280, and/or guardian n access device 290. The guardian access devices 270, 280, 290 may include any type of interface, such as a computer or monitor, that allows the guardian to communicate with the GMS 100. Guardian access devices 270, 280, 290 may include commercially available desktop computers, notebook computers, server computers, personal digital assistants (PDA's) as well as mobile computing and communications devices. Communications as referenced herein generally indicates the flow of information, and not necessarily any particular type of communication channel. The GMS 100 allows the guardian to enter constraints to be placed on his/her dependent in connection with the electronic services offered by the third party service provider 110, 120, 130.

The guardian interface block 300 includes dependent registration module 310. The guardian may communicate with the dependent registration module 310 to register the dependent and/or to update the information relating to the dependent (if the dependent is already registered in the GMS 100). The guardian may register himself/herself with the GMS 100. The guardian may generally provide a name, guardian e-mail address, and billing information, including card type, card number, and/or expiration date as generally illustrated in the data structure labeled FIG. 3C. The guardian may choose to provide additional information such as cell phone number, age, home telephone number, address, school district, birth date, and any other information that may be useful to other guardians affiliated with GMS 100 in finding other guardians that are affiliated with GMS 100 that may be known and/or trusted. The guardian may be associated with his/her dependents. As mentioned above, each guardian may be responsible for one or more dependents in accordance with an embodiment of the invention.

In registering with the GMS 100, the guardian provides identifying information about the dependent (in addition to the user name, password, and/or identifying information for the guardian that may be obtained by the third party service provider 110, 120, 130 and provided to the GMS 100 for token registration). This identifying information inputted into the dependent registration module 340 may include, for example, the dependent's name, address, gender, birth date, user names, passwords, and/or any other information that may be useful for the GMS 100 to facilitate the dependent's participation in connection with one or more services provided by third party service providers 110, 120, 130 and/or to facilitate the dependent's interaction in connection with one or more interactors, as generally illustrated in the data structure labeled FIG. 3D. The data structure may further include information regarding one or more third party service providers 110, 120, 130 that may be associated with the dependent. For example, as generally illustrated in FIG. 3E, the data structure for the third party service provider associated with the dependent may include user name, password, the unique token generated by the GMS, as well constraint information regarding the third party service provider. In registering with the GMS 100 and/or updating information relating to the dependent, the guardian may place constraints on the dependent's interaction with the third party service provider 110, 120, 130. For example, the guardian may place constraints on the type of services with which the dependent may interact (e.g., accessibility constraints), the time period during which any interaction with the services may take place (e.g., time of use constraints), the locations of such services (e.g., geographic location constraints), and/or the individuals or entities with whom the dependent may interact (e.g., social interaction with individuals/entities constraints). The constraint information for the third party service provider 110, 120, 130 is generally illustrated in the data structure labeled FIG. 3F. For example, the guardian may communicate via guardian access device 270, 280, 290 with the dependent registration module 310 that one or more of the guardian's dependents may only access specific web sites for a specified period of time. The registration information and/or update information obtained by the dependent registration module 310 is communicated with the data repository 230. The data structure may further include information regarding one or more interactors. For example, as generally illustrated in FIG. 3G, the data structure for the interactor may include a name, as well as constraint information regarding the interactor. For example, the guardian may place constraints on the dependent's interaction with the interactor (e.g., accessibility constraints and/or the geographic locations of the interactors (e.g., geographic location constraints). The constraint structure for the interactor is generally illustrated in the data structure labeled FIG. 3H. The data repository 230 stores this information and may include one or more memory modules (not shown) to store the information. The information may be collocated across differentiated repositories.

An embodiment in which the dependent first attempts to access a third party service provider 110, 120, 130 for the first time, and then the third party service provider 110, 120, 130 (either directly or through GMS 100) is configured to send a notification to the parent to initiate registration and/or initiate an update within the GMS 100 has been described in detail. However, it is understood by those of ordinary skill in the art that the guardian may also initiate registration and/or initiate an update with the GMS prior to his/her dependent seeking to access a third party service provider 110, 120, 130 in accordance with other embodiments of the invention. In accordance with this embodiment, the parent communicates with the dependent registration module 310 of the guardian interface block 300 of GMS 100 to provide information regarding a dependent, including for example, the dependent's user name at the third party service provider, the dependent's password at the third party service provider, and/or the guardian's e-mail address that has been provided to the third party service provider (i.e., part of the dependent base information). The dependent identifier registration module 210 may then generate and assign a token to the user name affiliated with the third party service provider (as well as any constraints), as generally illustrated in the data structures labeled FIGS. 3D-3H.

When a dependent subsequently attempts to access a third party service provider 110, 120, 130, they will be required to provide the username and password that they were either assigned by the third party service provider or that they were allowed to choose. When the dependent logs into the electronic service of the third party service provider 110, 120, 130, the third party service provider 110, 120, 130 is able to determine the unique token associated with the username. The third party service provider 110, 120, 130 queries the inquiry module/constraint retrieval module 220 of the third party service provider interface block 200 of the GMS 100 using the dependent's unique token. In this way, only the token is communicated, as opposed to the username, password, and/or any other information that may be considered more sensitive. The inquiry module/constraint retrieval module 220 of the GMS 100 communicates with the data repository 230 to obtain the user name corresponding to the unique token. The user name will be associated with the inquiring third party service provider 110, 120, 130. The Major Token List as generally illustrated in FIG. 3B may be used to locate the user name associated with the unique token. The user name (and third party service provider information) may then be used to locate the dependent that was registered with the dependent registration module 310. Alternatively, the dependent information may itself correlate the unique token to the dependent. Once the dependent is identified, the particular constraints that the guardian has placed on the dependent's interaction with the inquiring third party service provider 110, 120, 130 can be obtained or retrieved. The database structure for the constraints may be illustrated in FIG. 3F. The inquiry module/constraint retrieval module 220 then communicates the information relating to constraints associated with the third party service provider 110, 120, 130 to the third party service provider 110, 120, 130. Thus, the third party service provider 110, 120, 130 may allow the dependent to interact with the electronic service it offers in the manner defined by the dependent's guardian.

The functions described above performed by the computer-implemented GMS 100 may be realized as computer program code or code sections and further embodied in a computer readable storage medium. Such articles of manufacture formed by storage of such code or code sections on computer-readable storage media achieves the same advantages as the systems and methods described above. It should be understood that the GMS 100 (and the methods performed thereby) a described above may include conventional processing apparatus known in the art, capable of executing pre-programmed instructions stored in an associated memory, all performing in accordance with the functionality described herein. It is contemplated that the systems and methods described herein will be programmed in a preferred embodiment, with the resulting software being stored in an associated memory and may also constitute the particular means for performing such methods or functions thereof. In particular, at least the various blocks 200, 300 may constitute the means for performing the functions described in connection with each. Implementation of the invention, in software, in view of the foregoing enabling description would require no more than routine application of programming skills by one of ordinary skill in the art. Such a system may further be of the type having both ROM, RAM, a combination of non-volatile and volatile (modifiable) memory so that the software can be stored and yet allow storage and processing of dynamically produced data and/or signals.

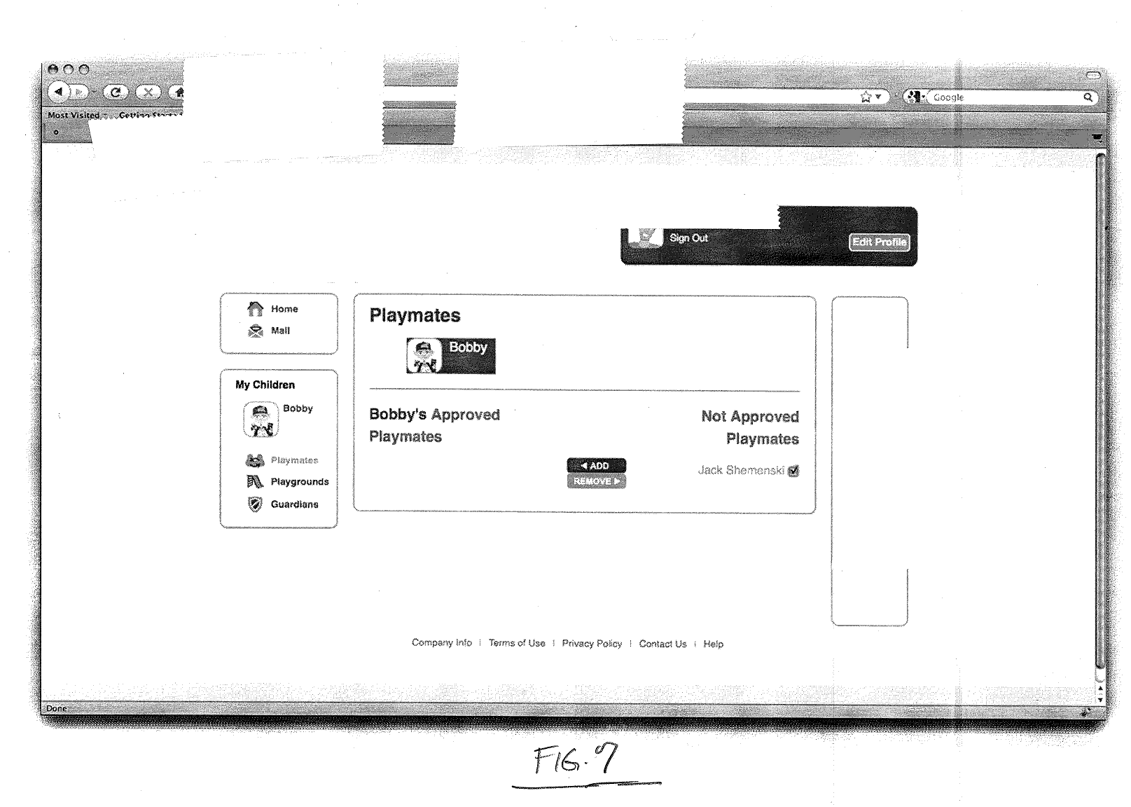

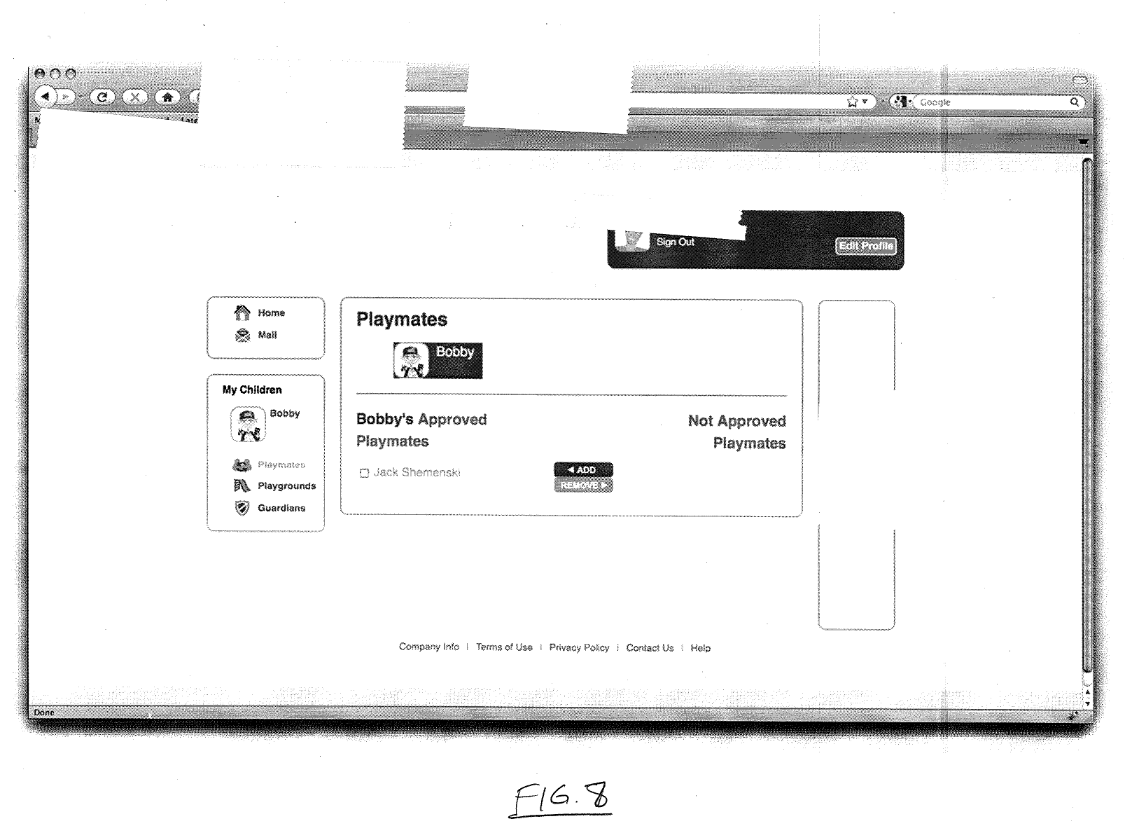

The GMS 100 may also be configured to allow guardians (e.g., guardian 1, guardian 2, guardian n) to communicate with other guardians, so as to invite other guardians to participate in the GMS 100. For example, the guardians may already have established communications, and thus, a guardian may invite another guardian to join the GMS 100. The GMS 100 may send an electronic invitation, for example, via e-mail or text, to another guardian. As described herein, the GMS 100 may be configured to allow communication over the world wide web (WWW) portion of the Internet, using well-established communication protocols, and will thus, include web server functionality configured to interact with conventional programs executing on the computing devices of other guardians not already registered with the GMS. The second guardian may receive the electronic invitation and be given an opportunity to register himself/herself and/or his/her dependents with the GMS 100 via the guardian interface block 300 of the GMS 100. The second guardian may choose to decline the invitation, or may choose to accept the invitation. If the second guardian chooses to accept the invitation, he second guardian may register himself/herself and his/her dependent in accordance with the procedure described herein. The GMS 100 may also be configured to allow registered guardians to establish relationships between and with other registered guardians. For example, as generally illustrated in FIG. 4, a first guardian may be advised via the GMS 100 that a second guardian wants to establish a relationship between the first and second guardian. The second guardian may choose to decline the invitation, and the GMS 100 is configured to provide a declination notification to the first guardian via the GMS 100. The second guardian may alternatively choose to accept the invitation, and the GMS 100 is configured to provide an acceptance notification to the first guardian via the GMS 100. After a second guardian has accepted an invitation to establish a relationship with a first guardian, and the first guardian receives the acceptance notification, the first guardian may be able to view a list of connections with other guardians using the GMS 100 as generally illustrated in FIG. 5.

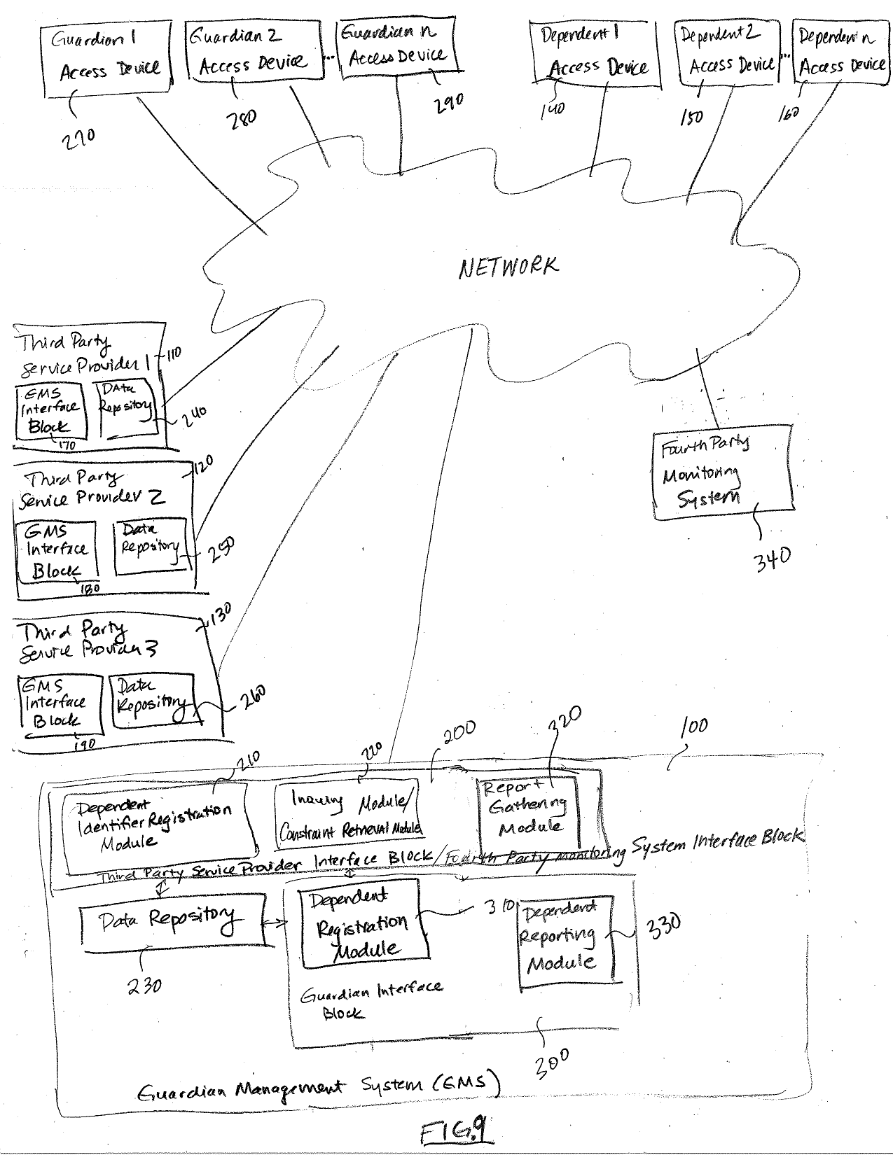

The GMS 100 may also be configured to invite guardians to allow interaction between dependents. For example, a guardian may wish to specify other dependents with whom his/her dependent may interact. For example, a guardian may wish to specify that one or more dependents may interact with one or more other dependents. The GMS 100 may send an electronic invitation, for example, via e-mail or text, to another guardian indicating that the first guardian would like to authorize interaction between one of the dependents of the first guardian and one of the dependents of the second guardian. As described herein, the GMS 100 may be configured to allow the guardian to compose a notification to another guardian and communicate the notification to another guardian. The GMS 100 may be configured to allow for communication over the world wide web (WWW) portion of the Internet, using well-established communication protocols. The second guardian may receive the electronic invitation and be given an opportunity to authorize the relationship between the dependents. The second guardian may choose to decline the invitation, and the GMS 100 is configured to provide a declination notification to the first guardian via the GMS 100. The first guardian may then be able to view that the dependent of the second guardian is not approved for authorization with the dependent of the first guardian as generally illustrated in FIG. 7. The second guardian may alternatively choose to accept the invitation, and the GMS 100 is configured to provide an acceptance notification to the first guardian via the GMS 100. The first guardian may then be able to view that the dependent of the second guardian is approved for authorization with the dependent of the first guardian as generally illustrated in FIG. 8.

In accordance with another embodiment of the invention, the third party service provider 110, 120, 130 may monitor the activities of a dependent relating to the services provided by the third party service provider 110, 120, 130. The GMS interface block 170, 180, 120 of third party service provider 110, 120, 130 may be configured to provide information regarding the activities of the dependent to the GMS 100. For example, the GMS interface block 170, 180, 190 of the third party service provider 110, 120, 130 may be configured to identify when a dependent has logged into the third party service provider 110, 120, 130 based on the dependent's user name. The third party service provider 110, 120, 130 sends a timestamp, along with the dependent's unique token, to a report gathering module 320 of the GMS 100. The GMS 100 may then record the login time for the dependent. The login time for the dependent may be stored in the data repository 230. The login time for the dependent may then be presented to the guardian for the dependent via a dependent reporting module 330. The GMS interface block 170, 180, 190 of the third party service provider 110, 120, 130 may also be configured to identify when a dependent has logged out of the third party service provider 110, 120, 130. The third party service provider 110, 120, 130 sends a timestamp, along with the dependent's unique token, to the report gathering module 320 of the GMS 100. The GMS may then record the logout time for the dependent. The logout time for the dependent may be stored in the data repository 230. The logout time for the dependent may then be presented to the guardian for the dependent via the depending reporting module 330. The timestamp information may also be stored by the third party service provider 110, 120, 130. Although a timestamp for login and a timestamp for logout are mentioned in detail, the information relating to the activities of the third party service provider 110, 120, 130 that may be monitored and reported to the GMS 100 may be any number of other type/formats of information in accordance with other embodiments of the invention.

For example, the third party service provider 110, 120, 130 may be configured to generate an activity report for a dependent. The activity report may include any information relating to the activities of the dependent using the services of the third party service provider 110, 120, 130. The third party service provider 110, 120, 130 sends the activity report, along with the dependent's unique token, to the report gathering module 320 of the GMS 100. The GMS 100 may then store the activity report for the dependent in the data repository 230. The activity report for the dependent may then be presented to the guardian for the dependent via the dependent reporting module 330. In an embodiment, the GMS 100 may send an acknowledgment to the third party service provider 110, 120, 130 regarding receipt of the activity report for the dependent.

In accordance with another embodiment of the invention, the network may include a fourth party monitoring system 340. The fourth party monitoring system 340 may monitor the activities of a dependent relating to the services provided by a third party service provider 110, 120, 130 and may be configured to generate, store, index, and provide information (e.g., behavioral reports and/or status updates) regarding the activities of the dependent to the GMS 100. The report gathering module 320 of the GMS 100 may send a request for a behavioral report and/or status update for a dependent to the fourth party monitoring system 340. The request for a behavioral report and/or status update may be provided by the GMS 100 along with the dependent's unique token to the fourth party monitoring system 340. The fourth party monitoring system 340 may locate the behavioral report and/or status update for the dependent based on the unique token that was sent by the GMS 100. The fourth party monitoring system 340 may forward the behavioral report and/or status update to the GMS 100. The GMS 100 may then store the behavioral report and/or status update for the dependent in the data repository 230.

The behavioral report and/or status update for the dependent may then be presented to the guardian for the dependent via the dependent reporting module 330. In an embodiment, the GMS 100 may send an acknowledgment to the third party service provider 110, 120, 130 regarding receipt of the behavioral report and/or status update for the dependent.

In accordance with an embodiment of the invention, a guardian registered with the GMS 100 may access the GMS 100 and request report data regarding a dependent's activities with various third party service providers 110, 120, 130. The GMS 100 may locate all report data (e.g., login, logout, activity report, behavioral reports, status updates, and the like) relating to a dependent from the data repository 230. The GMS 100 may aggregate all activity and behavioral data stored in the data repository 230 relating to the dependent. The dependent reporting module 330 of the GMS 100 may be configured to report the aggregated data to the guardian. Either or both of the third party service provider 110, 120, 130 and the fourth party monitoring system 340 may be configured to monitor, store, and report the activities of a dependent registered with the GMS 100.

The invitation and monitoring functions described above performed by the computer-implemented GMS 100 may also be realized as computer program code or code sections and further embodied in a computer readable storage medium. Such articles of manufacture formed by storage of such code or code sections on computer-readable storage media achieves the same advantages as the systems and methods described above. It should be understood that the GMS 100 (and the methods performed thereby) a described above may include conventional processing apparatus known in the art, capable of executing pre-programmed instructions stored in an associated memory, all performing in accordance with the functionality described herein. It is contemplated that the systems and methods described herein will be programmed in a preferred embodiment, with the resulting software being stored in an associated memory and may also constitute the particular means for performing such methods or functions thereof. In particular, at least the various blocks 200, 300 may constitute the means for performing the functions described in connection with each. Implementation of the invention, in software, in view of the foregoing enabling description would require no more than routine application of programming skills by one of ordinary skill in the art. Such a system may further be of the type having both ROM, RAM, a combination of non-volatile and volatile (modifiable) memory so that the software can be stored and yet allow storage and processing of dynamically produced data and/or signals.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. The invention has been described in great detail in the foregoing specification, and it is believed that various alterations and modifications of the invention will become apparent to those skilled in the art from a reading and understanding of the specification. It is intended that all such alterations and modifications are included in the invention, insofar as they come within the scope of the appended claims. It is intended that the scope of the invention be defined by the claims appended hereto and their equivalents.

What is claimed:

1. A computer-implemented method for allowing a guardian for a dependent to manage electronic services provided by a third party service provider to the dependent, comprising the steps of:
establishing an account for the dependent with the third party service provider by providing at least one item of dependent information;
communicating the at least one item of dependent information from the third party service provider to a guardian management system;
generating a token that is associated with the at least one item of dependent information;
storing the at least one item of dependent information and the token at the guardian management system;
communicating the token to the third party service provider;
storing the at least one item of dependent information and the token at the third party service provider;
communicating the token to the guardian;
receiving at least one constraint on access to the third party service provider from the guardian;
associating the at least one constraint with the token; and
using the token to retrieve the at least one constraint when the dependent accesses the electronic services provided by the third party service provider.

2. The computer-implemented method of claim 1, wherein the dependent information comprises at least one of a user name, a password, and contact information for the guardian.

3. The computer-implemented method of claim 1, wherein the token comprises an alphanumeric string.

4. The computer-implemented method of claim 1, wherein the third party service provider may be assigned an application programming interface key.

5. The computer-implemented method of claim 1, wherein the at least one constraint comprises an accessibility constraint, a time of use constraint, a geographic location constraint, or a social interaction with individuals/entities constraint.

6. The computer-implemented method of claim 1, further comprising the steps of:
monitoring the electronic services provided by a third party service provider to the dependent to determine information regarding activities of the dependent;
communicating the information regarding activities of the dependent to the guardian management system;
storing the information regarding activities of the dependent at the guardian management system; and
presenting the information regarding activities of the dependent to the guardian.

7. A guardian management system for allowing a guardian for a dependent to manage electronic services provided by a third party service provider to the dependent, comprising:
a third party interface block configured to enable communication between the guardian management system and the third party service provider;
a dependent identifier registration module configured to generate a token associated with the dependent and the third party service provider;
a guardian interface block configured to enable communication between the guardian management system and the guardian;
a dependent registration module configured to enable the guardian to define at least one constraint on access to the third party service provider, the at least one constraint associated with the token;
a data repository in communication with the dependent identifier registration module and the dependent registration module and configured to store the token and the at least one constraint associated with the token; and
an inquiry module configured to retrieve the at least one constraint using the token and communicate the at least one constraint to the third party service provider.

8. The guardian management system of claim 7, further comprising:
a report gathering module configured to receive information regarding activities of the dependent provided by the third party service provider along with the token.

9. The guardian management system of claim 8, further comprising:
a dependent reporting module configured to present the information regarding activities of the dependent to the guardian.

10. The guardian management system of claim 7, further comprising:
a report gathering module configured to receive information regarding activities of the dependent provided by a fourth party monitoring system along with the token.

11. The guardian management system of claim 10, further comprising:
a dependent reporting module configured to present the information regarding activities of the dependent to the guardian.
